(19) United States
(12) Patent Application Publication
(10) Pub. No.: US 2025/0193926 A1
(43) Pub. Date: Jun. 12, 2025

(54) Coordinated Spatial Reuse

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US)

(73) Assignee: Ofinno, LLC, Reston, VA (US)

(21) Appl. No.: 19/060,841

(22) Filed: Feb. 24, 2025

Related U.S. Application Data
(63) Continuation of application No. PCT/US2023/030660, filed on Aug. 21, 2023.
(60) Provisional application No. 63/400,765, filed on Aug. 25, 2022.

(51) Int. Cl. H04W 74/0808; H04B 17/309; H04W 52/24; H04W 52/36

(52) U.S. Cl. CPC H04W 74/0808; H04B 17/346; H04W 52/245; H04W 52/367

(57) ABSTRACT

An access point (AP) transmits a first physical layer protocol data unit (PPDU) comprising an indication to a first station (STA) to measure a receive power of a second PPDU transmitted by a second STA. The AP transmits to the first STA a third PPDU comprising an indication of a parameterized spatial reuse (PSR) parameter for use by the first STA to determine a transmit power for a fourth PPDU.

### CROSS-REFERENCE TO RELATED APPLICATIONS

This application is a continuation of International Application No. PCT/US2023/030660, filed Aug. 21, 2023, which claims the benefit of U.S. Provisional Application No. 63/400,765, filed Aug. 25, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of parameterized spatial reuse (PSR)-based spatial reuse (SR).

FIG. 4 illustrates an example trigger frame.

FIG. 5 illustrates an example PSR encoding scheme.

FIG. 6 illustrates an example network that includes a coordinated AP set.

FIG. 7 illustrates an example of coordinated spatial reuse (CSR).

FIG. 8 illustrates another example of CSR.

FIG. 9 illustrates an example of dual-phase CSR.

FIG. 10 illustrates an example of dual-phase CSR in a multi slave AP environment.

FIG. 11 illustrates an example of CSR according to an embodiment.

FIG. 12 illustrates another example of CSR according to an embodiment.

FIG. 13 illustrates another example of CSR according to an embodiment.

FIG. 14 illustrates another example of CSR according to an embodiment.

FIG. 15 illustrates an example trigger frame which may be used in embodiments.

FIG. 16 illustrates an example CSR announcement frame which may be used in embodiments.

FIG. 17 illustrates an example process according to an embodiment.

FIG. 18 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

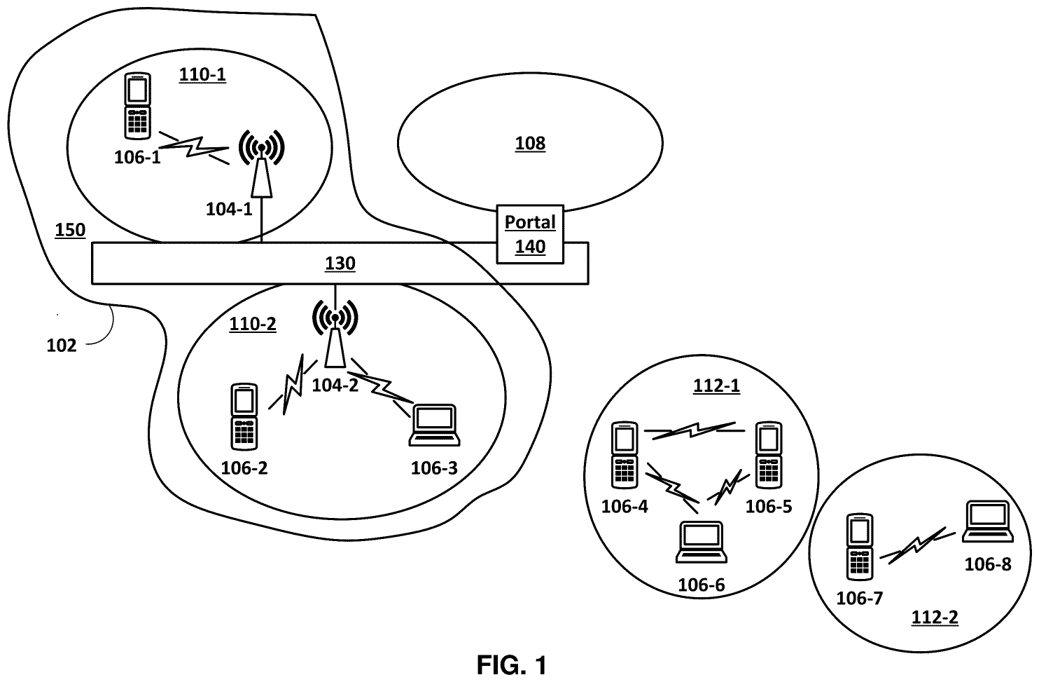

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

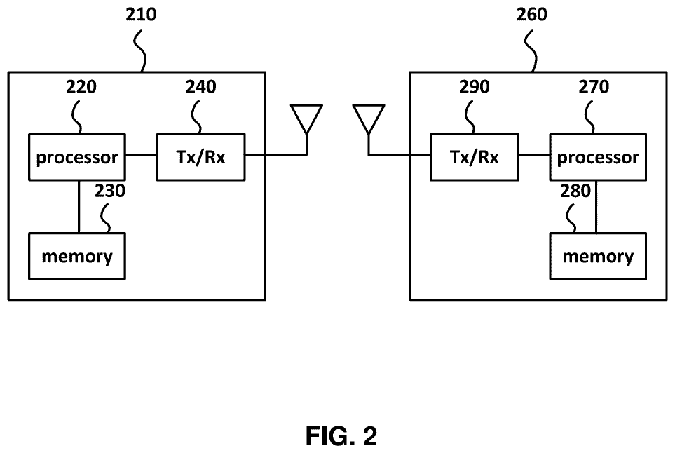

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

Spatial reuse (SR) in WLAN is an operation mode that allows a shared medium to be reused more often between overlapping BSSs (OBSSs), such as in dense deployment scenarios. SR relies on the early identification of signals from OBSSs and on interference management.

According to SR operation, a STA receiving a PPDU may classify the PPDU as an inter-BSS or an intra-BSS PPDU. From the perspective of a STA, an inter-BSS PPDU is a PPDU transmitted by an OBSS STA. On the other hand, an intra-BSS PPDU is a PPDU transmitted from the same BSS to which the STA belongs. The STA receiving the PPDU may use information in the PHY header and/or the MAC header (e.g., Transmit/Receive Address fields, BSS ID fields, etc.) to determine whether the PPDU is an inter-BSS or an intra-BSS PPDU. In some cases, the STA may not be able to determine whether a PPDU is an inter-BSS or an intra-BSS frame. In such cases, the STA may not be able to perform SR operation.

A STA that identifies a received PPDU as an inter-BSS PPDU may choose not to decode the PPDU and instead to perform channel access using High Efficiency (HE) or Extremely High Throughput (EHT) spatial reuse. Choosing not to decode a PPDU may provide power saving benefits to a STA as the STA may enter a micro sleep state for the duration of the PPDU, for example.

Two independent spatial reuse modes are defined in the IEEE 802.11 standard for both HE and EHT STAs: OBSS Packet Detect (OBSS PD)-based Spatial Reuse (OBSS PD-based SR) and Parameterized Spatial Reuse (PSR)-based Spatial Reuse (PSR-based SR).

OBSS PD-based SR is a spatial reuse mode in which STAs, under specific conditions, may ignore an inter-BSS PPDU when a sensitivity level (called the OBSS PD level) is lower than a packet detect clear channel assessment (CCA) sensitivity level. The packet detect CCA sensitivity level is −82 dBm for 20 MHz signals and increases proportional to the bandwidth of the signal (e.g., −79 dBm for 40 MHz and −76 dBm for 80 MHz). It is noted that, unlike the CCA sensitivity level, the OBSS PD level may be controlled dynamically by a STA to enhance its own SR operation.

PSR-based SR is another spatial reuse mode supported by HE and EHT STAs. PSR-based SR allows a STA to transmit within a duration of a Trigger Based (TB) PPDU sent from an OBSS network. A TB PPDU is a PPDU sent by a STA in response to a Triggering Frame. A Triggering Frame can be a Trigger Frame (TF) variant Control Frame or any frame with a Triggered Response Scheduling (TRS) control subfield in its MAC header. Opportunities for PSR-based SR are identified by the reception of an inter-BSS PPDU that contains a Triggering Frame.

Transmissions using PSR-based SR are controlled in terms of transmit power and/or duration by the STA that transmits the Triggering Frame. The STA may specify acceptable interference levels dynamically for each TB PPDU it solicits by the Triggering Frame.

For a STA, a PSR-based SR opportunity is identified if the following two conditions are met: Condition 1) The STA receives a Parameterized Spatial Reuse Reception (PSRR) PPDU (a PPDU that is identified as an inter-BSS PPDU and that contains a trigger frame); and Condition 2) The STA has a PPDU queued to be transmitted and the intended transmit power of the PPDU (this PPDU hereinafter is called PSR Transmission PPDU (PSRT PPDU)) in dBm, minus log10(PPDU_BW/20 MHz) dB, is below a power threshold value PSRT_TXP, where PPDU_BW represents a value in MHz of the bandwidth of the PSRR PPDU.

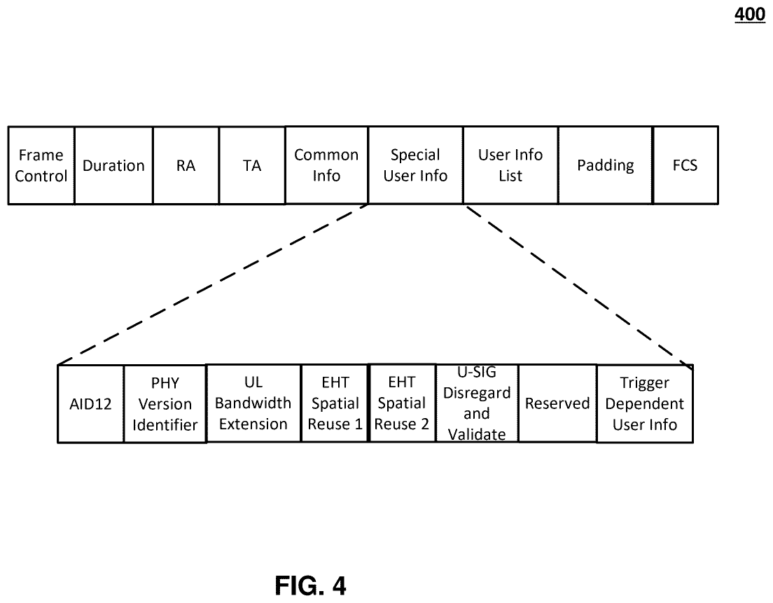

The power threshold value PSRT_TXP may be obtained by subtracting a parameter PSR indicated in 1) a UL Spatial Reuse field of the trigger frame contained in the PSRR PPDU (e.g., indicated in EHT Spatial Reuse 1 or 2 subfields of the trigger frame as shown in FIG. 4) or 2) the preamble of a TB PPDU that follows the PSRR PPDU (e.g., from a parameter RPL). The parameter RPL may be equal to the combined transmit power at a receive antenna connector, over the PSRR PPDU bandwidth, during the non-HE or non-EHT portion of the PSRR PPDU preamble, averaged over all antennas used to receive the PSRR PPDU.

A STA that identifies a PSR-based SR opportunity may issue a reset to its PHY circuitry to ignore (e.g., terminate reception of) any TB PPDU triggered by the trigger frame contained in the PSRR PPDU, provided that the BSS Color of the TB PPDU matches the BSS Color of the PSRR PPDU. A STA that identifies a PSR-based SR opportunity may not be allowed to transmit a PSRT PPDU that terminates beyond the duration of the TB PPDU that is triggered by the trigger frame contained in the PSRR PPDU.

For a STA, transmitting a PSRT PPDU may require detection of the PHY header of the TB PPDU following an identified PSRR PPDU. Because of this, transmission of the PSRT PPDU may only begin after the TB PPDU has been transmitted by a STA responding to the trigger frame contained in the PSRR PPDU. The transmission of the PSRT PPDU as well as any corresponding acknowledgements also needs to terminate at or before the end of the transmission of the TB PPDU.

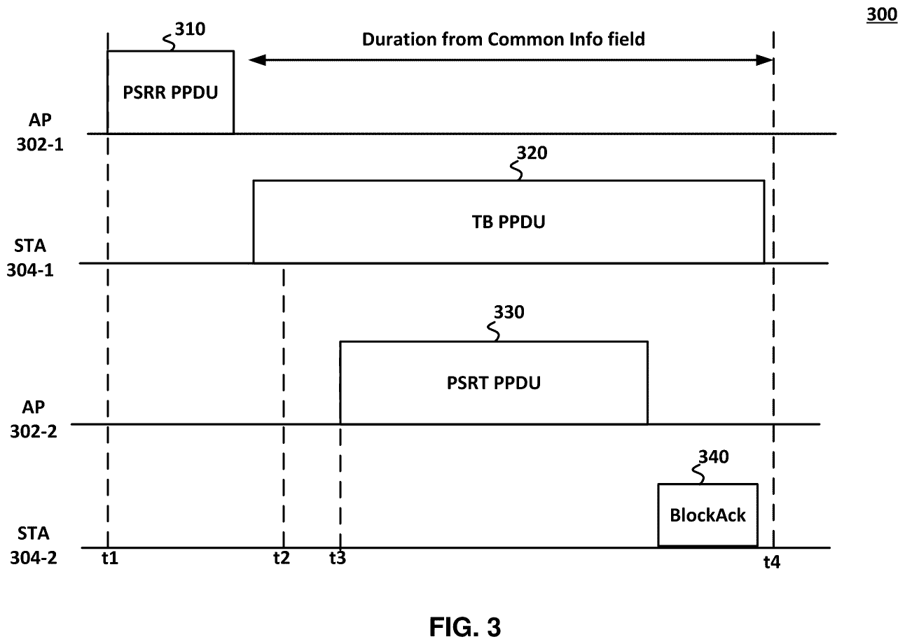

FIG. 3 illustrates an example 300 of PSR-based SR. As shown in FIG. 3, example 300 includes an AP 302-1, a STA 304-1, an AP 302-2, and a STA 304-2. In an example, AP 302-1 and STA 304-1 may belong to a different BSS (OBSS) than AP 302-2 and STA 304-2.

In an example, at a time t1, AP 302-1 may transmit a PSRR PPDU 310 containing a trigger frame to STA 304-1. The trigger frame may include a Spatial Reuse subfield containing a Duration field in a Common Info field or a Special User Info field which indicates to a PSRT PPDU transmitting STA the duration limit of a PSRT PPDU transmission (and any associated acknowledgments). The trigger frame may also include a Spatial Reuse subfield containing a parameter that may be used by a PSRT PPDU transmitting STA to compute a transmit power for the PSRT PPDU.

In response to PSRR PPDU 310, STA 304-1 may begin transmitting a TB PPDU 320 at a time t2. STA 304-1 may decode the Spatial Reuse subfields of the trigger frame contained in PSRR PPDU 310 and may copy the value of the Spatial Reuse subfield into a PHY header of TB PPDU 320.

On hearing TB PPDU 320, AP 302-2 may identify a PSR-based SR opportunity based on TB PPDU 320. Specifically, AP 302-2 may determine that both Conditions 1 and 2 for identifying a PSR-based SR opportunity, discussed above, are satisfied, i.e., PPDU 310 is an inter-BSS PPDU (determined by decoding either the PHY or the MAC header of PPDU 310) that contains a trigger frame (i.e., PPDU 310 is a PSRR PPDU for AP 302-2) and the PSRT_TXP computed based on PPDU 310 is sufficient for AP 302-2 to transmit a PSRT PPDU. AP 302-2 may then demodulate the PHY header of TB PPDU 320 to extract its BSS Color information. If the BSS Color matches the BSS Color indicated in the PSRR PPDU 310, AP 302-2 ignores TB PPDU 320.

Based on identifying the PSR-based SR opportunity based on TB PPDU 320, AP 302-2 may start transmitting a PSRT PPDU 330 at a time t3 to STA 304-2. AP 302-2 may set the duration of PSRT PPDU 330 such that an expected BlockACK 340 from STA 304-2 can be fully transmitted within the duration limit (ending at a time t4) indicated in the Common Info field of the trigger frame contained in PPDU 310.

FIG. 4 illustrates an example trigger frame 400. Example trigger frame 400 which may be used by an AP to solicit a TB PPDU from a STA. As described below, trigger frame 400 carries various information required by a responding STA to transmit a TB PPDU in response to trigger frame 400. Trigger frame 400 may be an EHT variant trigger frame supported by STAs that conform to the IEEE 802.11be standard amendment.

As shown in FIG. 4, trigger frame 400 may include a Frame Control field, a Duration field, a receiving address (RA) field, a transmitting address (TA) field, a Common Info field, a Special User Info field, a User Info List field, a Padding field, and an FCS field. The fields from the Frame Control field up to the TA field form a MAC header. The fields from the Common Info field up to the User Info List field form a MAC body.

The Frame Control field includes information of the type and subtype of trigger frame 400. This information may be used by a receiving STA to classify trigger frame 400 as a trigger frame.

The Duration field contains a duration value (in microseconds) which is used by a receiving STA to update a network allocation vector (NAV). The NAV is a counter that indicates to a STA an amount of time during which it must defer from accessing the shared medium.

The RA field may contain an individual MAC address value to specify a single receiving STA of trigger frame 400 or a broadcast address when trigger frame 400 is intended for multiple receiving STAs. The TA field may contain the address of the AP STA transmitting trigger frame 400.

The Common Info field is a variable size field containing information regarding the solicited TB PPDU. The information contained in the Common Info field is common to all STAs targeted by trigger frame 400. The information may include a Trigger Type, a length, and a bandwidth of the solicited TB PPDU.

Similar to the Common Info field, the Special User Info field may also contain information that is common to all STAs targeted by trigger frame 400. As shown in FIG. 4, this information may include an AID12 subfield, a PHY Version Identifier subfield, a UL Bandwidth subfield, an EHT Spatial Reuse 1 subfield, an EHT Spatial Reuse 2 subfield, a U-SIG Disregard and Validate subfield, a Reserved subfield, and a Trigger Dependent User Info subfield.

The AID12 subfield in the Special User Info field may be set to a fixed value (e.g., 2007) to differentiate the Special User Info field from a STA specific User Info field in the User Info List field.

The PHY Version Identifier subfield indicates the PHY version of the solicited TB PPDU. The PHY Version Identifier subfield may be set to 0 for EHT PHY and to a non-zero value for future post-EHT PHY versions.

The UL Bandwidth Extension subfield may include additional BW bits to support TB PPDU bandwidths up to 320 MHz.

The EHT Spatial Reuse 1 and 2 subfields carry values to be included in corresponding Spatial Reuse subfields in a U-SIG field of the solicited EHT TB PPDU. EHT Spatial Reuse 1 and 2 may be used to indicate a spatial reuse parameter in separate portions of the PPDU bandwidth.

The U-SIG Disregard and Validate subfield carries a value to be included in corresponding Disregard and Validate subfields of the U-SIG field of the solicited EHT TB PPDU.

The Reserved subfield is currently unused but may serve a purpose in future versions of the standard.

The Trigger Dependent User Info subfield may be used to carry additional signaling information depending on the type of trigger frame. Its size is variable and may not exist in some trigger frame types.

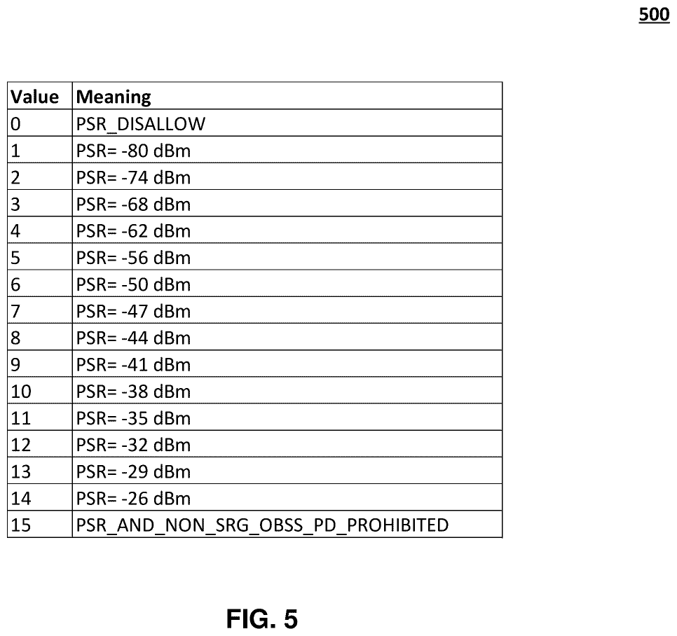

FIG. 5 illustrates an example PSR encoding scheme 500. Example encoding scheme 500 which may be used in a PSRR PPDU or an EHT PPDU. Specifically, example encoding scheme 500 may be used to encode the PSR value contained in the EHT Spatial Reuse subfields of a PSRR PPDU (e.g., EHT Spatial Reuse 1 and EHT Spatial Reuse 2 subfields) or an EHT TB PPDU. As shown in FIG. 5, in example encoding scheme 500, a PSR value of 0 indicates that PSR-based SR is not allowed by the AP STA. PSR values from 1 up to 14 each indicates that PSR-based SR is allowed and corresponds to a respective PSR value in dBm. The dBm PSR values indicated by PSR values 1-14 are numerically increasing signifying increasing tolerance for interference by the AP STA for the EHT TB PPDU. Finally, a PSR value of 15 indicates that both PSR-based SR and OBSS PD-based SR are not allowed.

As discussed above, a Transmit Opportunity (TXOP) owner can have more control over spatial reuse transmissions in PSR-based SR compared to OBSS PD-based SR. Nevertheless, both SR mechanisms suffer from the inability of the AP to limit the number of STAs transmitting via SR. For example, two or more STAs may each identify the same PPDU as a PSRR PPDU and may each transmit a PSRT PPDU. The simultaneously transmitted PSRT PPDUs may result in substantial interference at the STA that transmits the PSRR PPDU and may impact the reception by the STA of the TB PPDU transmitted in response to the PSRR PPDU.

Spatial reuse between BSSs in which the APs are coordinated can provide a stricter control on interference. In AP coordinated SR, only STAs inside BSSs whose APs are coordinating can transmit via SR. In addition, a STA sharing the medium using SR may indicate the BSS that is allowed to transmit using SR. Examples of SR with AP coordination are described further below.

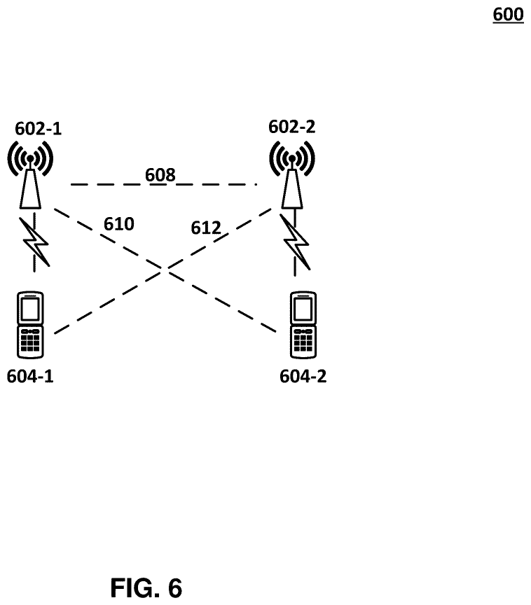

FIG. 6 illustrates an example network 600 that includes a coordinated AP set. As shown in FIG. 6, the coordinated AP set may include two APs—AP 602-1 and AP 602-2. At least one STA may be associated with each of APs 602-1 and 602-2. For example, a STA 604-1 may be associated with AP 602-1, and a STA 604-2 may be associated with AP 602-2.

APs 602-1 and 602-2 may belong to the same ESS as described above in FIG. 1. In such a case, APs 602-1 and 602-2 may be connected by a DS to support ESS features. In addition, as part of a coordinated AP set, APs 602-1 and 602-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 602-1 and 602-2 may act as a master AP and the other as a slave AP. The master AP is the AP that is the owner of the TXOP. The master AP shares frequency resources during the TXOP with the slave AP. When there are more than two APs in the coordinated set, a master AP may share its TXOP with only a subset of the coordinated AP set. The role of the master AP may change over time. For example, the master AP role may be assigned to a specific AP for a duration of time. Similarly, the slave AP role may be chosen by the master AP dynamically or can be pre-assigned for a duration of time.

Spatial reuse with AP coordination across multiple BSSs (known as Coordinated Spatial Reuse (CSR)) can be more stable than non-AP coordinated spatial reuse schemes such as OBSS PD-based SR and PSR-based SR. For example, in example network 600, APs 602-1 and 602-2 may perform a joint sounding operation in order to measure path loss (PL) on paths of network 600. For example, the joint sounding operation may result in the measurement of PL 608 for the path between APs 602-1 and 602-2, path loss 610 for the path between AP 602-1 and STA 604-2, and path loss 612 for the path between AP 602-2 and STA 604-1. The measured path loss information may then be shared between APs 602-1 and 602-2 (e.g., using the backhaul) to allow for simultaneous transmissions by APs 602-1 and 602-2 to their associated STAs 604-1 and 604-2 respectively. Specifically, one of APs 602-1 and 602-2 obtains a TXOP to become the master AP. The master AP may then send a CSR announcement frame to the other AP(s). In an embodiment, the master AP may perform a polling operation, before sending the CSR announcement frame, to poll slave APs regarding packet availability for transmission. If at least one slave AP responds indicating packet availability, the master AP may proceed with sending the CSR announcement frame. In the CSR announcement, the master AP may limit the transmit power of a slave AP in order to protect its own transmission to its target STA. The slave AP may similarly protect its own transmission to its target STA by choosing a modulation scheme that enables a high enough Signal to Interference Ratio (SIR) margin to support the interference due to the transmission of the master AP to its target STA.

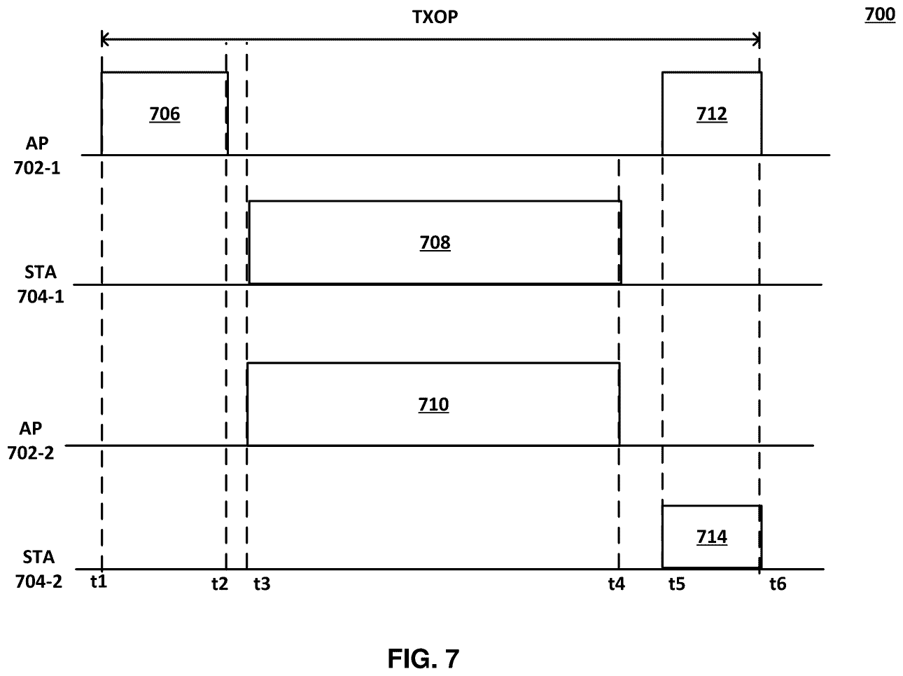

FIG. 7 illustrates an example 700 of coordinated spatial reuse (CSR). As shown in FIG. 7, example 700 includes APs 702-1 and 702-2 and STAs 704-1 and 704-2. STA 704-1 is associated with AP 702-1, while STA 704-2 is associated with AP 702-2. APs 702-1 and 702-2 are part of different BSSs and form a coordinated AP set. It is assumed, in example 700, that AP 702-1 is the master AP and that AP 702-2 is the slave AP in the coordinated AP set.

As shown in FIG. 7, AP 702-1 may obtain a TXOP that starts at a time t1 and that ends at a time t6. Prior to time t1, APs 702-1 and 702-2 may perform a path loss measurement procedure (e.g., joint sounding) to measure path loss to and from each other. Using the path loss information, AP 702-1 computes a maximum transmit power that AP 702-2 may use to transmit during a CSR transmission coinciding with the TXOP. In an embodiment, AP 702-1 may set the maximum transmit power such that a TB PPDU transmitted by STA 704-1 during the TXOP will be received at AP 702-1 successfully even with a concurrent transmission from AP 702-2. For example, if a transmission data rate of the TB PPDU requires a maximum acceptable interference equal to X, the maximum transmit power, TxAP2pwr, for AP 702-2 may be set as equal to (X+PL), where PL is the path loss from AP 702-2 to AP 702-1.

In an example operation, as shown in FIG. 7, AP 702-1 may transmit a frame 706 that starts at time t1 and that ends at time t2. Frame 706 may be a Triggering Frame for STA 704-1 to transmit a frame 708. In the same frame 706, AP 702-1 may also inform AP 702-2 that it may transmit a frame using CSR during the TXOP. AP 702-1 may indicate to AP 702-2 in frame 706 a frequency resource, a transmit start time, a transmit duration, and a maximum transmit power that AP 702-2 is allowed to use.

At a time t3, STA 704-1 may start transmitting frame 708 to AP 702-1 in response to frame 706. At the same time, AP 702-2 may start transmitting a frame 710 to STA 704-2. In example 700, it is assumed that APs 702-1 and 702-2 use a single frequency resource (e.g., a single frequency band). Frames 708 and 710 may be acknowledged by AP 702-1 and STA 704-2, respectively, with frames 712 and 714, respectively. Transmission of frames 712 and 714 may start at a time t5 and may end at or before time t6, the end time of the TXOP.

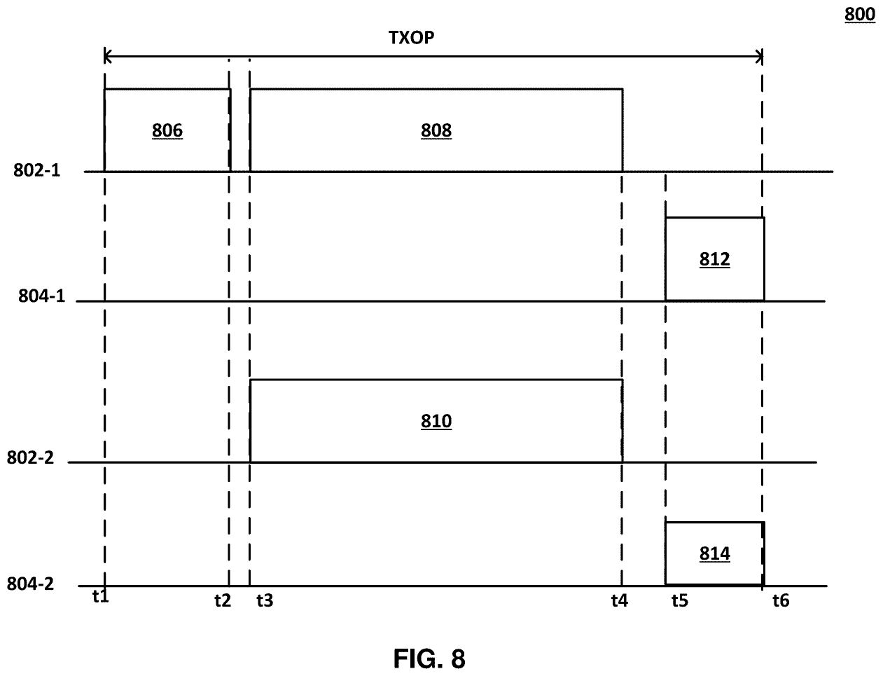

FIG. 8 illustrates another example 800 of CSR. As shown in FIG. 8, example 800 includes APs 802-1 and 802-2 and STAs 804-1 and 804-2. STA 804-1 is associated with AP 802-1, while STA 804-2 is associated with AP 802-2. APs 802-1 and 802-2 are part of different BSSs and form a coordinated AP set. It is assumed, in example 800, that AP 802-1 is the master AP and that AP 802-2 is the slave AP in the coordinated AP set.

As shown in FIG. 8, AP 802-1 may obtain a TXOP that starts at a time t1 and that ends at a time t6. Prior to time t1, APs 802-1 and 802-2 may perform a path loss measurement procedure (e.g., joint sounding) to measure path loss to and from each other. Using the path loss information, AP 802-1 computes a maximum transmit power that AP 802-2 may use to transmit during a CSR transmission coinciding with the TXOP. In an embodiment, AP 802-1 may set the maximum transmit power such that a DL PPDU transmitted by AP 802-1 during the TXOP will be received at STA 804-1 successfully even with a concurrent transmission from AP 802-2.

In an example operation, as shown in FIG. 8, AP 802-1 may transmit a frame 806 that starts at time t1 and that ends at time t2. Frame 806 may inform AP 802-2 that it may transmit a frame using CSR while AP 802-1 transmits a downlink frame during the TXOP. AP 802-1 may also indicate to AP 802-2 in frame 806 a frequency resource, a transmit start time, a transmit duration, and a maximum transmit power that AP 802-2 is allowed to use.

At a time t3, AP 802-1 may start transmitting a downlink frame 808 to STA 804-1. At the same time, AP 802-2 may start transmitting a frame 810 to STA 804-2. In example 800, it is assumed that APs 802-1 and 802-2 use a single frequency resource (e.g., a single frequency band). Frames 808 and 810 may be acknowledged by STAs 804-1 and 804-2, respectively, with frames 812 and 814, respectively. Transmission of frames 812 and 814 may start at a time t5 and may end at or before time t6, the end time of the TXOP.

To allow STA 804-1 to receive frame 808 with a sufficient SIR margin, a maximum transmit power of AP 802-2 for frame 810 must be set based on the PL from AP 802-2 to STA 804-1. For example, if a maximum interference level of X is required for frame 808 at STA 804-1, AP 802-1 may calculate the maximum transmit power, TxAP2pwr, of AP 802-2 for frame 810 as equal to (X+PL), where PL is the path loss from AP 802-2 to STA 804-1.

It is noted that, in example 800, determining by AP 802-1 the maximum transmit power of AP 802-2 for frame 808 requires knowledge of the PL from AP 802-2 to STA 801-1, instead of the PL between APs 802-1 and 802-1 as in example 700. This PL from an OBSS AP (AP 802-2) to target STA (STA 804-1) may not always be available to AP 802-1 and may not be obtained by the path loss measurement procedure performed by the APs prior to the CSR operation. In such a case, AP 802-1 may not be able to initiate the CSR operation as illustrated in example 800 without an additional PL measurement phase between an OBSS AP and an associated STA such as STA 804-1.

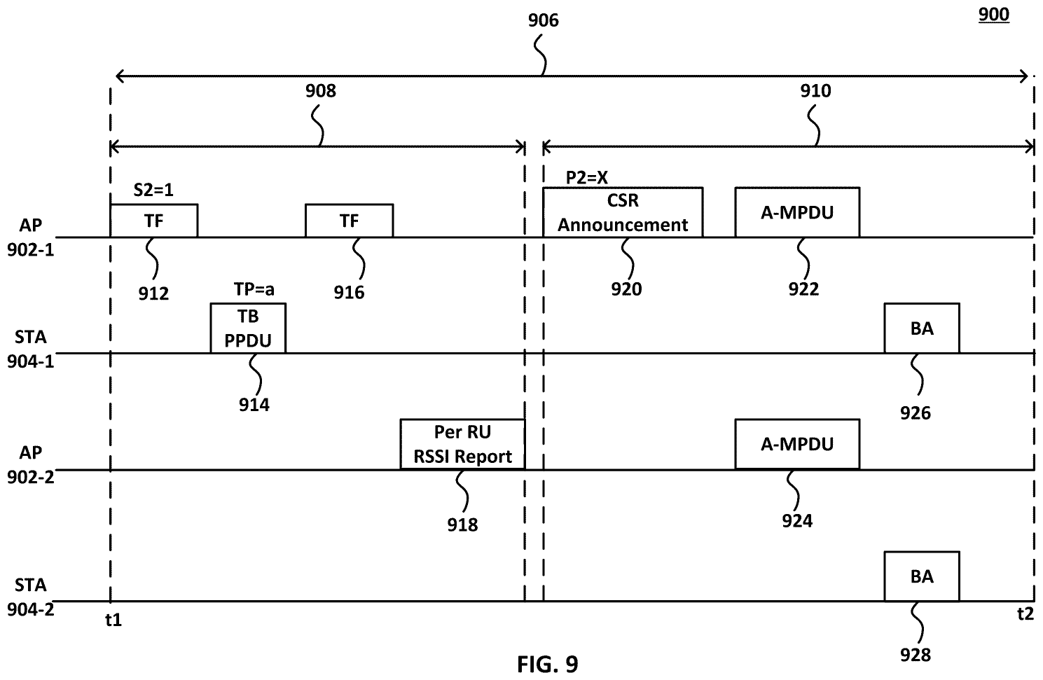

FIG. 9 illustrates an example 900 of dual-phase CSR. As shown in FIG. 9, example 900 includes APs 902-1 and 902-2 and STAs 904-1 and 904-2. STA 904-1 is associated with AP 902-1, while STA 904-2 is associated with AP 902-2. APs 902-1 and 902-2 are part of different BSSs and form a coordinated AP set. It is assumed, in example 900, that AP 902-1 is the master AP and that AP 902-2 is the slave AP in the coordinated AP set.

As shown in FIG. 9, AP 902-1 may obtain a TXOP that starts at a time t1 and that ends at a time t2. Dual-phase CSR within the TXOP includes a Receive Signal Strength Indicator (RSSI) feedback collection phase 908 and a CSR operation phase 910.

RSSI feedback collection phase 908 allows the master AP, AP 902-1, to obtain path loss information to and from slave APs, such as AP 902-2. RSSI feedback collection phase 908 may be performed by AP 902-1 while soliciting uplink TB PPDUs from associated STAs, such as STA 904-1. For example, as shown in FIG. 9, AP 902-1 may transmit a trigger frame 912 to solicit a TB PPDU 914 from STA 904-1. AP 902-1 may include in trigger frame 912 an indication S2 to AP 902-2 instructing AP 902-2 to measure a per resource unit (RU) RSSI of TB PPDU 914. STA 904-1 may also indicate its transmit power (TP) information in TB PPDU 914 to aid in the estimation of path loss from STA 904-1 to other STAs. Whether STA 904-1 indicates its TP in TB PPDU 914 may also be in response to an indication in trigger frame 912.

On receiving trigger frame 912, AP 902-2 processes the indication S2 and proceeds to measure the per RU RSSI of TB PPDU 914 transmitted by STA 904-1. AP 902-2 may digitize the measured per RU RSSI and encode it using a small number of bits to make it easier to send as feedback to AP 902-1. The feedback may be in a form of a Per RU RSSI Report.

On receiving TB PPDU 914, AP 902-1 may send another trigger frame 916 addressed to AP 902-2 soliciting its Per RU RSSI Report based on TB PPDU 914. In response, AP 902-2 transmits a Per RU RSSI Report frame 918 containing the per RU RRSI of TB PPDU 914 to AP 902-1.

On receiving Per RU RSSI Report frame 918, AP 902-1 may decode the measured Per RU RSSI contained in frame 918 and may use it to estimate the PL from STA 904-1 to AP 902-2. For example, the PL from STA 904-1 to AP 902-2 may be computed as PL21=TxSTA1pwr−RxAP2pwr, where TxSTA1pwr represents the transmit power of STA 904-1 used to transmit TB PPDU 914, and where RxAP2pwr represents the per RU RSSI measured by AP 902-2 based on TB PPDU 914. It is noted that AP 902-1 may obtain the value of TxSTA1pwr by decoding the TP information included by STA 904-1 in TB PPDU 914.

As shown in FIG. 9, CSR operation phase 910 follows RRSI feedback collection phase 908 and may begin with AP 902-1 initiating a CSR operation by transmitting a CSR Announcement frame 920 in order to share its remaining TXOP with AP 902-2. AP 902-1 may indicate to AP 902-2 in CSR Announcement frame 920 a frequency resource, a transmit start time, a transmit duration, and a maximum transmit power (P2) that AP 902-2 is allowed to use. The value of P2 may be determined by AP 902-1 such that a downlink frame transmission by AP 902-2 to STA 904-2 does not impact the reception of STA 904-1 of a concurrent downlink frame transmission from AP 902-1. For example, if a maximum interference level of X is required for the downlink frame transmission from AP 902-1 at STA 904-1, AP 902-1 may calculate the maximum transmit power, TxAP2pwr, of AP 902-2 for its downlink frame transmission to STA 904-2 as equal to X+PL21, where PL21 is the path loss from AP 902-2 to STA 904-1. It is noted that PL21 may be obtained by AP 902-1 in RSSI feedback collection phase 908.

Subsequently, APs 902-1 and 902-2 may perform simultaneous downlink frame transmissions to STAs 904-1 and 904-2 respectively. Specifically, AP 902-1 may transmit an A-MPDU 922 to STA 904-1, and AP 902-2 may transmit an A-MPDU 924 to STA 904-2. STAs 904-1 and 904-2 may acknowledge A-MPDUs 922 and 924 by transmitting BA frames 926 and 928, respectively.

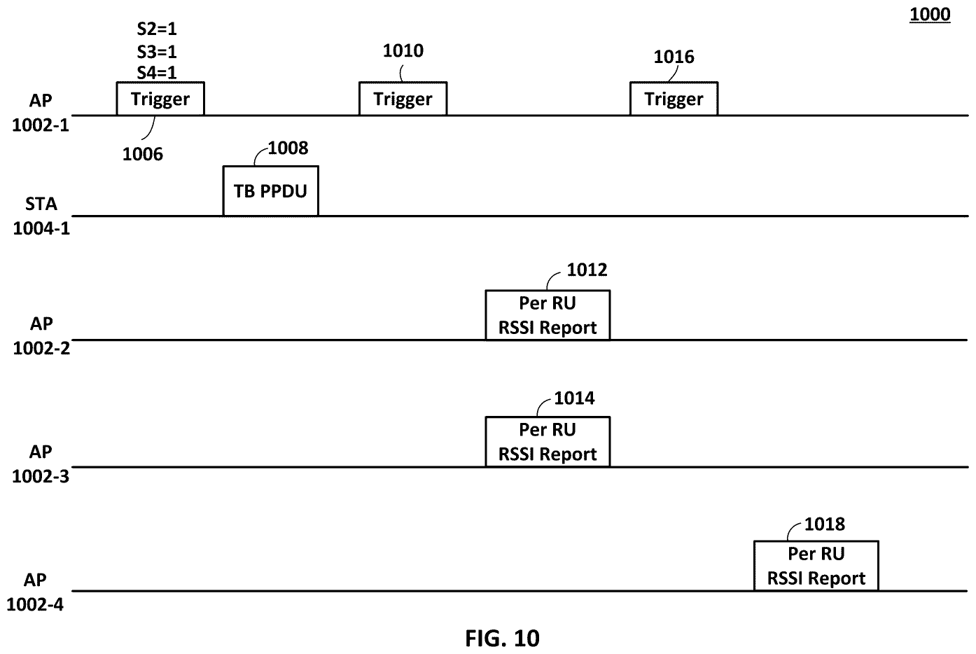

FIG. 10 illustrates an example 1000 of dual-phase CSR in a multi slave AP environment. As shown in FIG. 10, example 1000 includes APs 1002-1, . . . , 4 and a STA 1004-1. STA 1004-1 is associated with AP 1002-1. APs 1002-2, 1002-3, and 1002-4 belong to different BSSs than AP 1002-1. AP 1002-1 forms a coordinated AP set with APs 1002-2, 1002-3, and 1002-4. It is assumed, in example 1000, that AP 1002-1 is the master AP and that APs 1002-2, 1002-3, and 1002-4 are slave APs in the coordinated AP set.

As shown in FIG. 10, AP 1002-1 may transmit a trigger frame 1006 to solicit a TB PPDU 1008 from STA 1004-1. AP 1002-1 may include in trigger frame 1006 indications S2, S3, and S4 instructing APs 1002-2, 1002-3, and 1002-4 respectively to measure a per RU RSSI of TB PPDU 1008. STA 1004-1 may also indicate its transmit power (TP) information in TB PPDU 1008 to aid in the estimation of path loss from STA 1004-1 to other STAs. Whether STA 1004-1 indicates its TP in TB PPDU 1008 may also be in response to an indication in trigger frame 1006.

On receiving trigger frame 1006, APs 1002-2, 1002-3, and 1002-4 process respectively the indications S2, S3, and S4 and each proceeds to measure the per RU RSSI of TB PPDU 1008 transmitted by STA 1004-1. AP 1002-2, 1002-3, and 1002-4 may each digitize the measured per RU RSSI and encode it in the form of a Per RU RSSI Report.

On receiving TB PPDU 1008, AP 1002-1 proceeds to collect the measured per RU RSSI Reports from APs 1002-2, 1002-3, and 1002-4. Depending on the number of per RU RSSI Reports to be collected, AP 1002-1 may send one or more trigger frames soliciting the measured per RU RSSI Reports. In example 1000, AP 1002-1 may send a trigger frame 1010 addressed to APs 1002-2 and 1002-3 soliciting their per RU RSSI Reports based on TB PPDU 1008. In response, APs 1002-2 and 1002-3 transmit to AP 1002-1 respectively Per RU RSSI Report frames 1012 and 1014 containing their respective per RU RRSI Reports of TB PPDU 1008. Subsequently, AP 1002-1 may send another trigger frame 1016 addressed to AP 1002-4 soliciting its per RU RSSI Report based on TB PPDU 1008. In response, APs 1002-4 transmits to AP 1002-1 a Per RU RSSI Report frame 1018 containing its per RU RRSI Report of TB PPDU 1008.

As illustrated in example 1000, the collection of the measured per RU RSSI feedback in a multi slave AP environment may incur a large overhead. Specifically, as shown, AP 1002-1 may have to transmit multiple trigger frames to solicit and collect the measured per RU RSSI Reports from all of slave APs 1002-2, 1002-3, and 1002-4. When the number of slave APs is large (e.g., greater than two), the collection process becomes excessively inefficient. Further, the collection process may become lengthy rendering the collected RSSI reports less accurate for the subsequent CSR operation phase.

Embodiments of the present disclosure address this problem by enabling a slave AP in a coordinated AP set to calculate its own transmit power for a CSR operation. By doing so, the master AP is relieved from the task of calculating and transmitting a transmit power to each of the slave APs, and, by consequence, the per RU RSSI feedback collection phase can be eliminated. The resulting CSR process is thus made more resource efficient and quicker to establish. Additionally, as the CSR process no longer relies on RSSI feedback, which may become stale, the transmit power calculation can be more accurate with direct effect on transmission quality during the CSR operation.

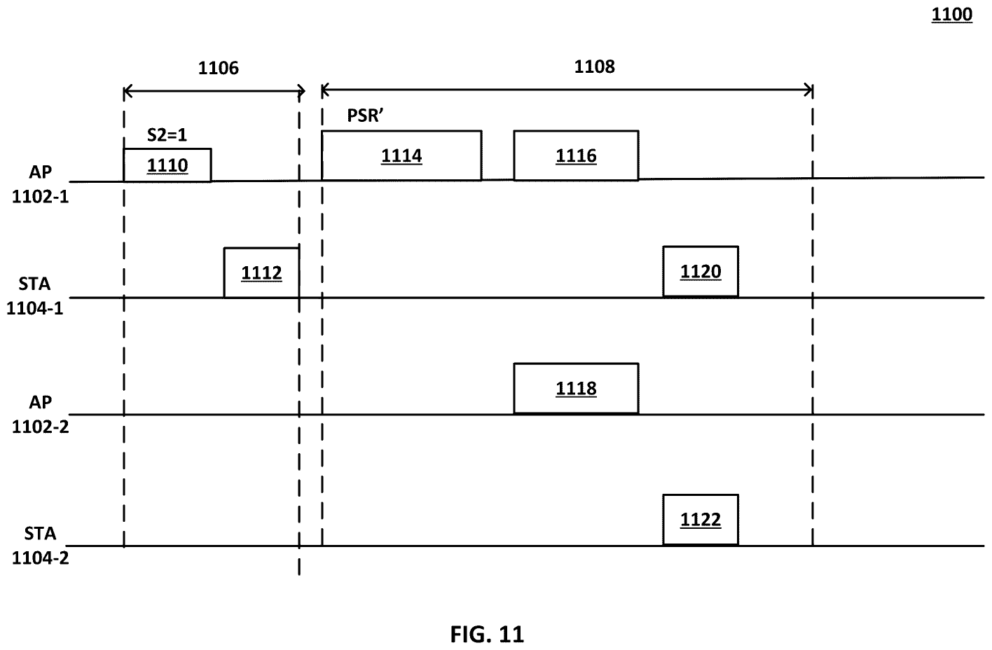

FIG. 11 illustrates an example 1100 of CSR according to an embodiment. Example 1100 is provided for the purpose of illustration only and is not limiting of embodiments. As shown in FIG. 11, example 1100 includes APs 1102-1 and 1102-2 and STAs 1104-1 and 1104-2. STA 1104-1 is associated with AP 1102-1, while STA 1104-2 is associated with AP 1102-2. APs 1102-1 and 1102-2 are part of different BSSs and form a coordinated AP set. It is assumed, in example 1100, that AP 1102-1 is the master AP and that AP 1102-2 is the slave AP in the coordinated AP set.

As shown in FIG. 11, the CSR process includes an RSSI measurement phase 1106 and a CSR operation phase 1108.

In the RSSI measurement phase 1106, AP 1102-1 may transmit a trigger frame 1110 to solicit a TB PPDU 1112 from STA 1104-1. AP 1102-1 may include in trigger frame 1110 an indication S2 to AP 1102-2 instructing AP 1102-2 to measure a RSSI of TB PPDU 1112. STA 1104-1 may also include its transmit power (TP) information in TB PPDU 1112. Whether STA 1104-1 indicates its TP in TB PPDU 1112 may also be in response to an indication in trigger frame 1110.

On receiving trigger frame 1110, AP 1102-2 processes the indication S2 and proceeds to measure the RSSI of TB PPDU 1112 transmitted by STA 1104-1. In an embodiment, AP 1102-2 may calculate a parameter RPL′ based on the measured RSSI of TB PPDU 1112. The parameter RPL′ may be equal to the combined transmit power at a receive antenna connector, over the bandwidth of TB PPDU 1112, during the non-HE or non-EHT portion of the preamble of TB PPDU 1112, averaged over all antennas used to receive TB PPDU 1112.

On receiving TB PPDU 1112, AP 1102-1 calculates a modified PSR parameter, hereinafter referred to as PSR′, to allow AP 1102-2 to compute, on its own, a maximum transmit power for the subsequent CSR operation phase. In an embodiment, AP 1102-1 calculates PSR′ such that STA 1104-1 can receive a frame 1116 transmitted from AP 1102-1 with a sufficient SIR margin in the presence of a concurrent transmission of a frame 1118 from AP 1102-2 to STA 1104-2. In an embodiment, if a maximum interference of X is required for frame 1116 at STA 1104-1, AP 1102-1 may calculate the parameter PSR′ as equal to (TxSTA1pwr+X), where TXSTA1pwr is the transmit power of STA 1104-1 for TB PPDU 1112. It is reminded that TXSTA1pwr is indicated by STA 1104-1 to AP 1102-1 in TB PPDU 1112.

Subsequently, AP 1102-1 may transmit a CSR announcement frame 1114 in order to share its remaining TXOP with AP 1102-2. AP 1102-1 may indicate to AP 1102-2 in CSR announcement frame 1114 a frequency resource, a transmit start time, and a transmit duration. Additionally, AP 1102-1 includes in CSR announcement frame 1114 the modified PSR parameter, PSR′, calculated by AP 1102-1 as described above.

On receiving CSR announcement frame 1114, AP 1102-2 computes a maximum transmit power for the CSR operation based on the modified PSR parameter, PSR′. In an embodiment, AP 1102-2 calculates the maximum transmit power, TXAP2pwr, as equal to PSR′−RPL′. It is reminded that the parameter RPL′ is derived by AP 1102-2 based on the measured RSSI of TB PPDU 1112.

Subsequently, as shown in FIG. 11, APs 1102-1 and 1102-2 may perform simultaneous downlink frame transmissions to STAs 1104-1 and 1104-2 respectively. Specifically, AP 1102-1 may transmit frame 1116 to STA 1104-1, and AP 1102-2 may transmit frame 1118 to STA 1104-2. In transmitting frame 1118, AP 1102-2 makes sure not to exceed the maximum transmit power that it calculated for the CSR operation. STAs 1104-1 and 1104-2 may acknowledge frames 1116 and 1118 by transmitting BA frames 1120 and 1122, respectively.

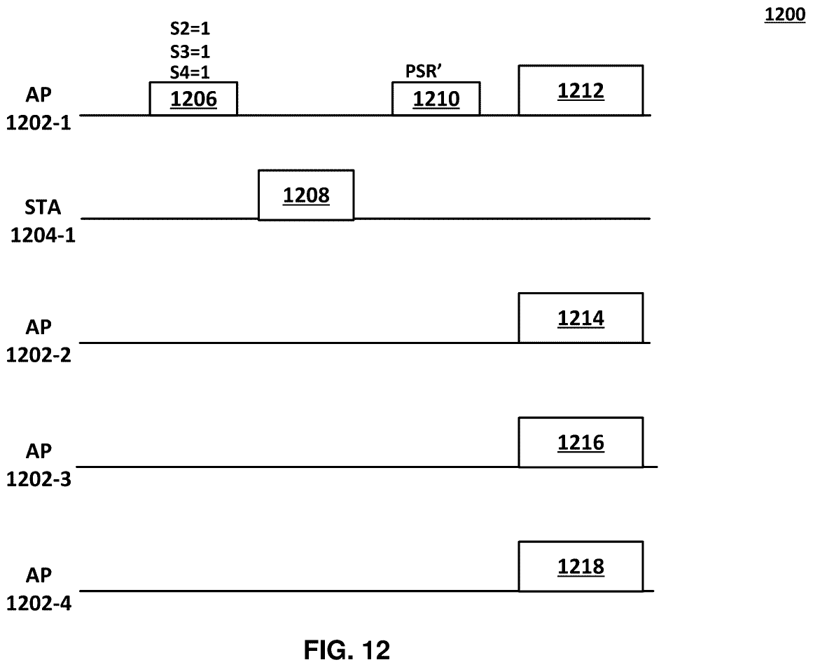

FIG. 12 illustrates another example 1200 of CSR according to an embodiment. Example 1200 is provided for the purpose of illustration only and is not limiting of embodiments. As shown in FIG. 12, example 1200 includes APs 1202-1, . . . , 4 and STA 1204-1. STA 1204-1 is associated with AP 1202-1. APs 1202-2, 1202-3, and 1202-4 belong to different BSSs than AP 1202-1. AP 1202-1 forms a coordinated AP set with APs 1202-2, 1202-3, and 1202-4. It is assumed, in example 1200, that AP 1202-1 is the master AP and that APs 1202-2, 1202-3, and 1202-4 are slave APs in the coordinated AP set.

As shown in FIG. 12, AP 1202-1 may transmit a trigger frame 1206 to solicit a TB PPDU 1208 from STA 1204-1. AP 1202-1 may include in trigger frame 1206 indications S2, S3, and S4 instructing APs 1202-2, 1202-3, and 1202-4 respectively to measure a RSSI of TB PPDU 1208. STA 1204-1 may also indicate its transmit power (TP) information in TB PPDU 1208. Whether STA 1204-1 indicates its TP in TB PPDU 1208 may also be in response to an indication in trigger frame 1206.

On receiving trigger frame 1206, APs 1202-2, 1202-3, and 1202-4 process respectively the indications S2, S3, and S4 and proceeds to measure the RSSI of TB PPDU 1208 transmitted by STA 1204-1. In an embodiment, each of APs 1202-2, 1202-3, and 1202-4 may calculate a respective parameter RPL′ based on the measured RSSI of TB PPDU 1208. The parameter RPL′ may be equal to the combined transmit power at a receive antenna connector, over the bandwidth of TB PPDU 1208, during the non-HE or non-EHT portion of the preamble of TB PPDU 1208, averaged over all antennas used to receive TB PPDU 1208.

On receiving TB PPDU 1208, AP 1202-1 calculates a modified PSR parameter, hereinafter referred to as PSR′, to allow each of APs 1202-2, 1202-3, and 1202-4 to compute, on its own, a maximum transmit power for the subsequent CSR operation phase.

In an embodiment, a common PSR′ is calculated for all of APs 1202-2, 1202-3, and 1202-4. In an embodiment, AP 1202-1 calculates PSR′ such that STA 1204-1 can receive a frame 1212 transmitted from AP 1202-1 with a sufficient SIR margin in the presence of a concurrent transmission of frames 1214, 1216, and 1218 from APs 1202-2, 1202-3, and 1202-4 respectively. In an embodiment, if a maximum interference level of X is required for frame 1212 at STA 1204-1, AP 1202-1 may calculate the parameter PSR′ as equal to (TXSTA1pwr+X) where TXSTA1pwr is the transmit power of STA 1204-1 for TB PPDU 1208. It is reminded that TXSTA1pwr is indicated by STA 1204-1 to AP 1202-1 in TB PPDU 1208.

In another embodiment, a dedicated PSR′, PSR1′, PSR2′, PSR3′, is calculated for each of APs 1202-2, 1202-3, and 1202-4. In an embodiment, the maximum interference level X required for frame 1212 at STA 1204-1 may be considered as an aggregate of interference levels X2, X3, and X4, where X is a function of X2, X3 and X4. The dedicated PSR′ for APs 1202-2, 1202-3, and 1202-4 may be calculated as PSR2′=(TxSTA1pwr+X2), PSR3′=(TxSTA1pwr+X3), and PSR4′=(TxSTA1pwr+X4) respectively.

Subsequently, AP 1202-1 may transmit a CSR announcement frame 1210 in order to share its remaining TXOP with APs 1202-2, 1202-3, and 1202-4. AP 1202-1 may indicate to each of APs 1202-2, 1202-3, and 1202-4 in CSR Announcement frame 1210 a respective frequency resource, a respective transmit start time, and a respective transmit duration. Additionally, AP 1202-1 includes in CSR announcement frame 1210 the modified PSR parameter(s), PSR2′, PSR3′, PSR4′, calculated by AP 1202-1 as described above.

On receiving CSR announcement frame 1210, APs 1202-2, 1202-3, and 1202-4 each computes a respective maximum transmit power for the CSR operation based on the modified PSR parameter, PSR′. In an embodiment, APs 1202-2, 1202-3, and 1202-4 each calculates a respective maximum transmit power, TXAP2pwr, TXAP3pwr, TXAP4pwr as equal to PSR2′−RPL′, PSR3′−RPL′ and PSR4′−RPL′ respectively. It is reminded that the parameter RPL′ is derived by each of APs 1202-2, 1202-3, and 1202-4 based on the measured RSSI of TB PPDU 1208.

Subsequently, as shown in FIG. 12, APs 1202-2, 1202-2, 1202-3, and 1202-4 may perform simultaneous downlink frame transmissions of frames 1212, 1214, 1216, and 1218, respectively. In transmitting frames 1214, 1216, and 1218 respectively, APs 1202-2, 1202-3, and 1202-4 each makes sure not to exceed the respective maximum transmit power that it calculated for the CSR operation.

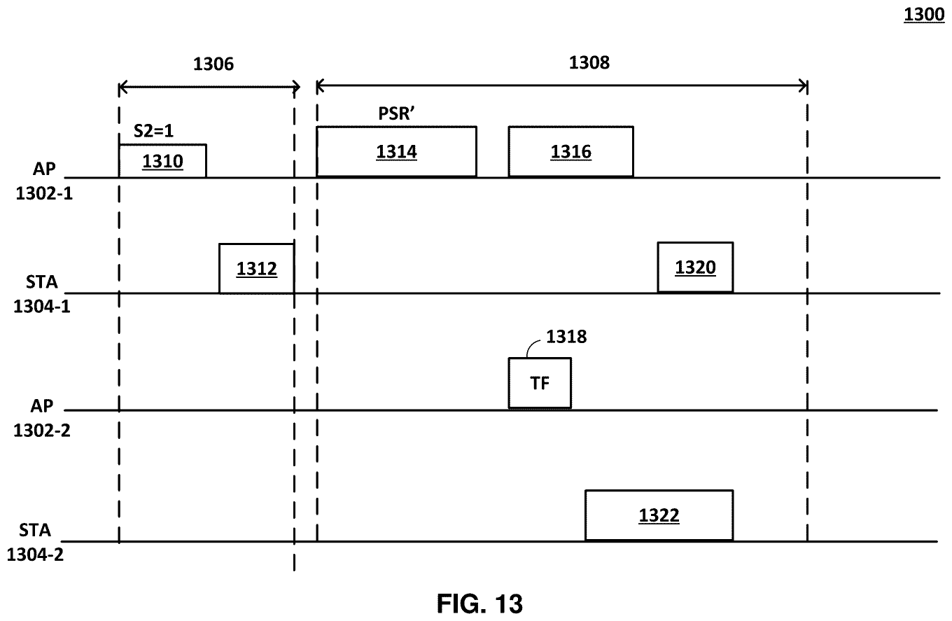

FIG. 13 illustrates another example 300 of CSR according to an embodiment. Example 1300 is provided for the purpose of illustration only and is not limiting of embodiments. As shown in FIG. 13, example 1300 includes APs 1302-1 and 1302-2 and STAs 1304-1 and 1304-2. STA 1304-1 is associated with AP 1302-1, while STA 1304-2 is associated with AP 1302-2. APs 1302-1 and 1302-2 are part of different BSSs and form a coordinated AP set. It is assumed, in example 1300, that AP 1302-1 is the master AP and that APs 1302-2 is the slave AP in the coordinated AP set.

As shown in FIG. 13, the CSR process includes an RSSI measurement phase 1306 and a CSR operation phase 1308.

In the RSSI measurement phase 1306, AP 1302-1 may transmit a trigger frame 1310 to solicit a TB PPDU 1312 from STA 1304-1. AP 1302-1 may include in trigger frame 1310 an indication S2 to AP 1302-2 instructing AP 1302-2 to measure a RSSI of TB PPDU 1312. STA 1304-1 may also indicate its transmit power (TP) information in TB PPDU 1312. Whether STA 1304-1 indicates its TP in TB PPDU 1312 may also be in response to an indication in trigger frame 1310.

On receiving trigger frame 1310, AP 1302-2 processes the indication S2 and proceeds to measure the RSSI of TB PPDU 1312 transmitted by STA 1304-1. In an embodiment, AP 1302-2 may calculate a parameter RPL′ based on the measured RSSI of TB PPDU 1312. The parameter RPL′ may be equal to the combined transmit power at a receive antenna connector, over the bandwidth of TB PPDU 1312, during the non-HE or non-EHT portion of the preamble of TB PPDU 1312, averaged over all antennas used to receive TB PPDU 1312.

On receiving TB PPDU 1312, AP 1102-1 calculates a modified PSR parameter, hereinafter referred to as PSR′, to allow AP 1302-2 to compute, on its own, a maximum transmit power for the subsequent CSR operation phase. In an embodiment, AP 1302-1 calculates PSR′ such that STA 1304-1 can receive a frame 1316 transmitted from AP 1302-1 with a sufficient SIR margin in the presence of a concurrent transmission of a trigger frame 1318 from AP 1302-2 to STA 1304-2. In an embodiment, if a maximum interference level of X is required for frame 1316 at STA 1304-1, AP 1302-1 may calculate the parameter PSR′ as equal to (TxSTA1pwr+X), where TXSTA1pwr is the transmit power of STA 1304-1 for TB PPDU 1312. It is reminded that TXSTA1pwr is indicated by STA 1304-1 to AP 1302-1 in TB PPDU 1312.

Subsequently, AP 1302-1 may transmit a CSR announcement frame 1314 in order to share its remaining TXOP with AP 1302-2. AP 1302-1 may indicate to AP 1302-2 in CSR Announcement frame 1314 a frequency resource, a transmit start time, and a transmit duration. Additionally, AP 1302-1 includes in CSR announcement frame 1314 the modified PSR parameter, PSR′, calculated by AP 1302-1 as described above.

On receiving CSR announcement frame 1314, AP 1302-2 computes a maximum transmit power for the CSR operation based on the modified PSR parameter, PSR′. In an embodiment, AP 1302-2 calculates the maximum transmit power, TXAP2pwr, as equal to PSR′−RPL′. It is reminded that the parameter RPL is derived by AP 1302-2 based on the measured RSSI of TB PPDU 1312.

Subsequently, as shown in FIG. 13, APs 1302-1 and 1302-2 may perform simultaneous downlink frame transmissions to STAs 1304-1 and 1304-2 respectively. Specifically, AP 1302-1 may transmit frame 1316 to STA 1304-1, and AP 1302-2 may transmit trigger frame 1318 to STA 1304-2. In transmitting trigger frame 1318, AP 1302-2 makes sure not to exceed the maximum transmit power that it calculated for the CSR operation. STA 1304-1 may acknowledge frame 1316 from AP 1302-1 by transmitting BA frame 1320. In response to trigger frame 1318 from AP 1302-2, STA 1304-2 transmits a TB PPDU 1322 to AP 1302-2.

In an embodiment, AP 1302-1 may include in trigger frame 1310 an indication to STA 1304-2 instructing STA 1304-2 to measure an RSSI of TB PPDU 1312. STA 1304-2 may then restrict its transmit power for the transmission of TB PPDU 1322 in the same fashion as done by AP 1302-2 for trigger frame 1318. Specifically, STA 1304-2 may derive the parameter RPL′ based on the measured RSSI of TB PPDU 1312 and determine its maximum transmit power as PSR′−RPL′, with PSR′ obtained from CSR announcement frame 1314.

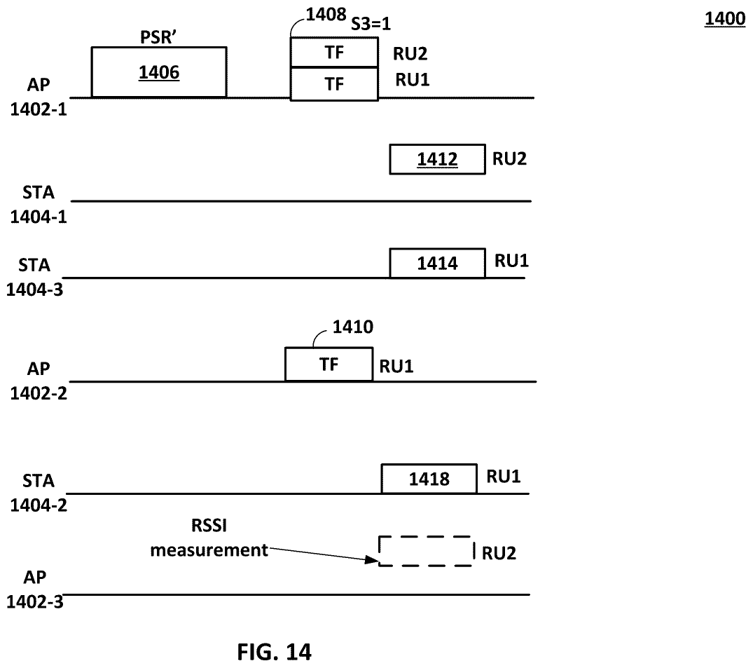

FIG. 14 illustrates another example 1400 of CSR according to an embodiment. Example 1400 is provided for the purpose of illustration only and is not limiting of embodiments. As shown in FIG. 14, example 1400 includes APs 1402-1, 1402-2, and 1402-3 and STAs 1404-1, 1404-2 and 1404-3. STAs 1404-1 and 1404-3 are associated with AP 1402-1, while STA 1404-2 is associated with AP 1402-2. APs 1402-2 and 1402-3 belong to different BSSs than AP 1402-1. AP 1402-1 forms a coordinated AP set with APs 1402-2 and 1402-3. It is assumed, in example 1400, that AP 1402-1 is the master AP and that APs 1402-2 and 1402-3 are slave APs in the coordinated AP set.

In an embodiment, the CSR process includes an RSSI measurement phase (not shown in FIG. 14) and a CSR operation phase. The CSR operation phase is done in parallel with a regular trigger-based uplink transmission in frequency resource units (RU) RU1 and RU2, respectively.

In the RSSI measurement phase, AP 1402-1 may transmit a trigger frame to solicit a TB PPDU from STA 1404-1. AP 1402-1 may include in the trigger frame an indication to AP 1402-2 instructing AP 1402-2 to measure a RSSI of the TB PPDU from STA 1404-1. STA 1404-1 may also indicate its transmit power (TP) information in the TB PPDU.

On receiving the trigger frame from AP 1402-1, AP 1402-2 processes the indication contained in the trigger frame and proceeds to measure the RSSI of the TB PPDU transmitted by STA 1404-1. In an embodiment, AP 1402-2 may calculate a parameter RPL′ based on the measured RSSI of the TB PPDU. The parameter RPL′ may be equal to the combined transmit power at a receive antenna connector, over the bandwidth of the TB PPDU, during the non-HE or non-EHT portion of the preamble of the TB PPDU, averaged over all antennas used to receive TB PPDU.

On receiving the TB PPDU from STA 1404-1, AP 1402-1 calculates a modified PSR parameter, PSR′, to allow AP 1402-2 to compute, on its own, a maximum transmit power for the subsequent CSR operation phase. In an embodiment, AP 1402-1 calculates PSR′ such that STA 1404-1 can receive a trigger frame 1408 in RU1 transmitted from AP 1402-1 with a sufficient SIR margin in the presence of a concurrent transmission of a trigger frame 1410 from AP 1402-2 to STA 1404-2. In an embodiment, if a maximum interference level of X is required for trigger frame 1408 at STA 1404-1, AP 1402-1 may calculate the parameter PSR′ as equal to (TxSTA1pwr+X), where TXSTA1pwr is the transmit power of STA 1404-1 for the TB PPDU. It is reminded that TXSTA1pwr is indicated by STA 1404-1 to AP 1402-1 in the TB PPDU.

Subsequently, AP 1402-1 may transmit a CSR announcement frame 1406 in order to share frequency resource RU1 for the remaining TXOP with AP 1402-2. AP 1402-1 may indicate to AP 1402-2 in CSR Announcement frame 1406 a frequency resource, a transmit start time, and a transmit duration. In example 1400, while frequency resource RU1 is used for the CSR operation, frequency resource RU2 is used for a regular Trigger Based Uplink transmission. Additionally, AP 1402-1 includes in CSR announcement frame 1406 the modified PSR parameter, PSR′, calculated by AP 1402-1 as described above.

On receiving CSR announcement frame 1406, AP 1402-2 computes a maximum transmit power for the CSR operation based on the modified PSR parameter, PSR′. In an embodiment, AP 1402-2 calculates the maximum transmit power, TXAP2pwr, as equal to PSR′−RPL′. It is reminded that the parameter RPL′ is derived by AP 1402-2 based on the measured RSSI of the TB PPDU transmitted by STA 1404-1.

Subsequently, as shown in FIG. 14, simultaneous trigger frame transmission may be performed by AP 1402-1 to STAs 1404-1 and 1404-3 and by AP 1402-2 to STA 1404-2 respectively. In transmitting trigger frame 1410, AP 1402-2 makes sure not to exceed the maximum transmit power that it calculated for the CSR operation. It is noted that the transmission of trigger frame 1408 from AP 1402-1 is duplicated in frequency resource RU1 and RU2. In trigger frame 1408, AP 1402-1 allocates frequency resource RU2 as a dedicated frequency resource for STA 1404-1 to transmit a TB PPDU and frequency resource RU1 as a frequency resource to perform CSR with AP 1402-2.

In an embodiment, AP 1402-1 may further include in trigger frame 1408 an indication S3 to AP 1402-3 instructing AP 1402-3 to measure the RSSI of TB PPDU 1412 to be transmitted by STA 1404-1 in response to trigger frame 1408.

STAs 1404-1 and 1404-3 respond to trigger frame 1408 by transmitting TB PPDUs 1412 and 1414, respectively. At the same time, STA 1404-2 responds to trigger frame 1410 by transmitting TB PPDU 1418. As shown in the FIG. 14, TB PPDUs 1414 and 1418 are transmitted via frequency resource RU1 while TB PPDU 1412 is transmitted via frequency resource RU2.

AP 1402-3 measures the RSSI of TB PPDU 1412 based on the indication S3 contained in trigger frame 1408. The RSSI measurement by AP 1402-3 allow AP 1402-1 to share a subsequent TXOP with AP 1402-3, knowing that AP 1402-3 may use the RSSI measurements made on TB PPDU 1412 to compute its maximum transmit power for a subsequent CSR operation. Specifically, the RRSI measurement made on TB PPDU 1412 allows AP 1402-3 to compute a maximum transmit power to transmit concurrently with AP 1402-1 without impacting reception at STA 1404-1.

As would be understood by a person of skill in the art based on the teachings herein, embodiments are not limited to the example embodiments described herein. For example, a person of skill in the art would appreciate that the proposed CSR process may be used for a variety of other frame types than described in the above examples. Similarly, the CSR process may be extended to scenarios in which protection is desired of a transmission by a slave AP rather than a master AP. In such scenarios, the concurrent transmissions may or may not include a transmission by the master AP.

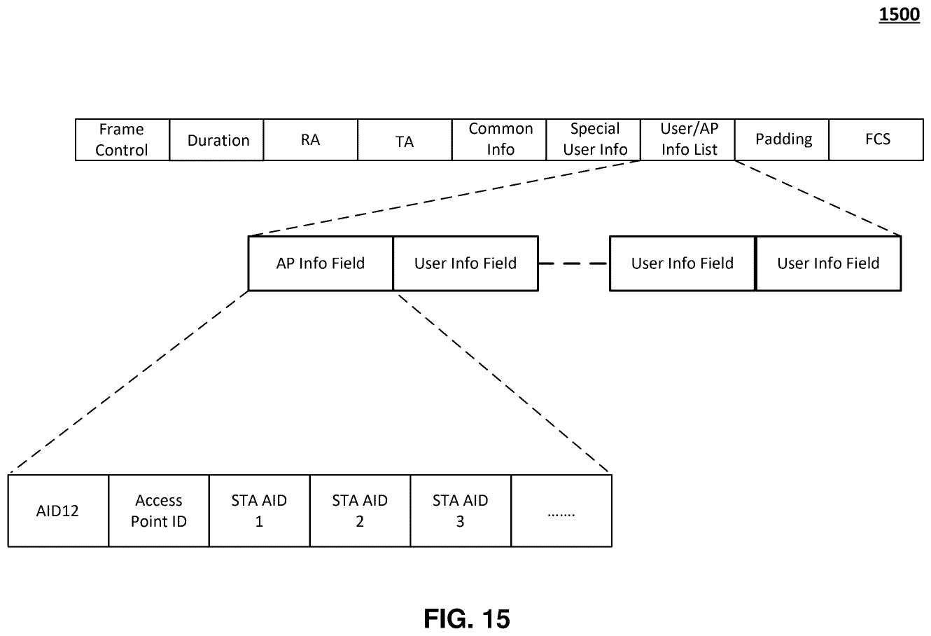

FIG. 15 illustrates an example trigger frame 1500 which may be used in embodiments. Example trigger frame 1500 is provided for the purpose of illustration only and is not limiting to embodiments. Example trigger frame 1500 may be used by a master AP to solicit a TB PPDU from an associated STA as well as to request that one or more slave AP measure the RSSI of the TB PPDU.

As shown in FIG. 15, example trigger frame 1500 may include a Frame Control field, a Duration field, a receiver address (RA) field, a transmitter address (TA) field, a Common Info field, a User/AP List Info field, a Padding Info field, and an FCS field. The Frame Control field, the Duration field, the RA field, the TA field, the Common Info field, and the FCS field may be similar to the corresponding fields of trigger frame 400 described above with reference to FIG. 4.

The User/AP Info List field is a modified version of the User Info List field of trigger frame 400. As shown, the User/AP Info List field may include one or more User Info fields each relating to a STA being solicited by trigger frame 1500 to transmit a TB PPDU. In addition, the User/AP Info List field may include one or more AP Info fields relating to one or more slave APs being requested to measure the RSSI(s) of the solicited TB PPDU(s).

In an embodiment, the AP Info field may include an AID12 subfield, an Access Point ID subfield, and one or more STA AID subfields. The AID12 subfield may be set to a specific value (e.g., 2700) that is different from the AID of any STA. This enables a STA receiving trigger frame 1500 to distinguish the AP Info field from a User Info field. The STA may ignore the contents of AP Info field upon decoding the value of the AID12 subfield.

The Access Point ID subfield indicates an identifier of the AP concerned by the AP Info field. The AP may be a slave AP as described above. The one or more STA AID subfields indicate one or more AIDs of STAs whose TB PPDU(s) (solicited by trigger frame 1500) are to be RSSI measured by the AP.

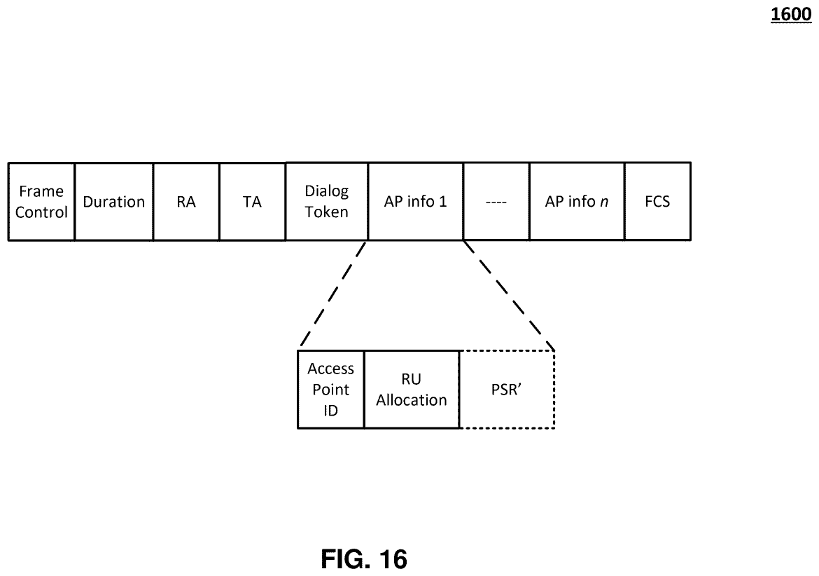

FIG. 16 illustrates an example CSR announcement frame 1600 which may be used in embodiments. Example CSR announcement frame 1600 is provided for the purpose of illustration only and is not limiting of embodiments. Example CSR announcement frame 1600 may be used by a master AP to announce an upcoming CSR operation.

As shown in FIG. 16, CSR announcement frame 1600 may include a Frame Control field, a Duration field, an RA field, a TA field, a Dialog Token field, one or more AP Info fields, and an FCS field. The Frame Control field, the Duration field, the RA field, the TA field, and the FCS field may be similar to the corresponding fields of trigger frame 400 described above with reference to FIG. 4.

The AP Info field may include an Access Point ID subfield, an RU Allocation subfield, and PSR′ subfield. The Access Point ID subfield indicates an identifier of the AP concerned by the AP Info field. The AP may be a slave AP as described above. The RU Allocation subfield indicates an RU allocation for use by the AP during the CSR operation. The PSR′ subfield indicates a PSR′ to the AP for use in the computation of its maximum transmit power during the CSR operation as described above.

It is noted that according to this embodiment, CSR announcement frame 1600 may indicate a PSR′ per slave AP involved in the CSR operation. In another embodiment, suitable for a configuration supporting a single PSR′ only for all slave APs, CSR announcement frame 1600 may be modified to include a Common Info field (e.g., before the one or more AP Info fields) that includes a PSR′ subfield. The AP Info field may then include the Access Point ID subfield and the RU Allocation subfield, but not the PSR′ subfield.

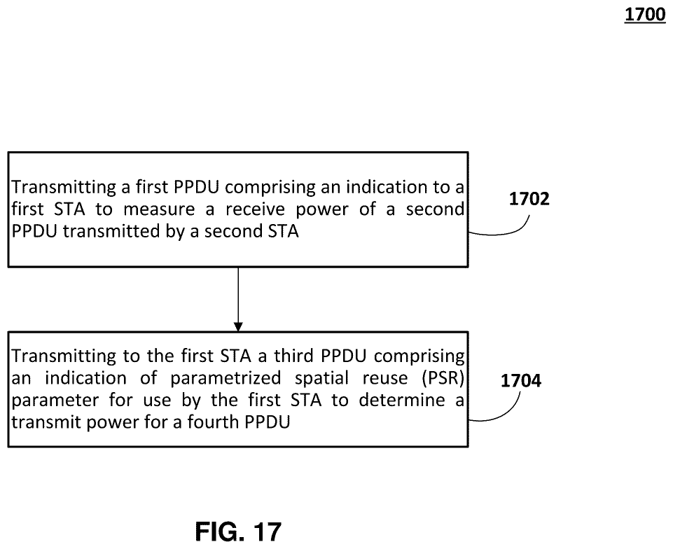

FIG. 17 illustrates an example process 1700 according to an embodiment. Example process 1700 is provided for the purpose of illustration only and is not limiting of embodiments. Example process 1700 may be performed by a CSR initiating STA, such as a master AP as described above. As shown in FIG. 17, example process 1700 may include steps 1702 and 1704.

In step 1702, process 1700 may include transmitting a first PPDU comprising an indication to a first STA to measure a receive power of a second PPDU transmitted by a second STA.

In an embodiment, the first STA may be an AP. For example, the AP and the first STA may be members of a coordinated set of APs. The first STA may be a slave AP in the coordinated set of APs.

In an embodiment, the first PPDU may further comprise an indication of a first resource allocated to the second STA for transmission of the second PPDU during a first time period. The first time period may start a Short Interframe Space (SIFS) duration after the first PPDU.

In an embodiment, the first PPDU may comprise a Triggering Frame.

In an embodiment, the second PPDU may comprise a TB PPDU. In another embodiment, the second PPDU may comprise a TB Null Data Packet (NDP).

In step 1704, process 1700 may include transmitting to the first STA a third PPDU comprising an indication of a PSR parameter for use by the first STA to determine a transmit power for a fourth PPDU. The PSR parameter may be a modified PSR parameter, PSR′, as described above.

In an embodiment, the third PPDU may comprise an Announcement Frame for APs in the coordinated set of APs. For example, the third PPDU may be a CSR Announcement frame.

In an embodiment, the transmit power for the fourth PPDU may be a maximum transmit power of the fourth PPDU.

In an embodiment, the third PPDU may further comprise an indication of a second resource allocated to the first STA for transmission of the fourth PPDU during a second time period. The second time period may start a SIFS duration after the third PPDU.

In an embodiment, the third PPDU may further comprise a duration of the fourth PPDU.

In an embodiment, the fourth PPDU may comprise a Triggering Frame that solicits a TB PPDU from a third STA.

In an embodiment, process 1700 may further comprise transmitting a fifth PPDU comprising a Data frame to the second STA during the second time period. The fifth PPDU may comprise a downlink (DL) Orthogonal Frequency Division Multiple Access (OFDMA) PPDU or a DL multi-user (MU) Multiple Input Multiple Output (MIMO) PPDU.

In an embodiment, process 1700 may further comprise determining the PSR parameter based on an interference level at the second STA while receiving the fifth PPDU. In an embodiment, the interference level at the second STA corresponds to a maximum interference level that the second STA tolerates, while receiving the fifth PPDU, due to transmission of the fourth PPDU by the first STA.

In an embodiment, process 1700 may further comprise transmitting a Triggering Frame soliciting a sixth PPDU from the first STA, the sixth PPDU indicating whether the first STA has pending frames to transmit. In an embodiment, the Triggering Frame may comprise an NDP Feedback Report Poll. In an embodiment, the sixth PPDU may comprise an NDP Feedback Report.

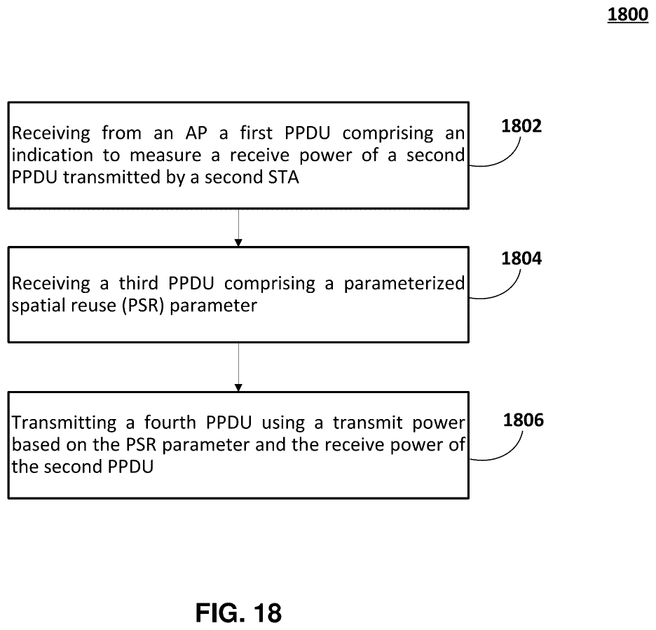

FIG. 18 illustrates another example process 1800 according to an embodiment. Example process 1800 is provided for the purpose of illustration only and is not limiting of embodiments. Example process 1800 may be performed by first STA. The first STA may be a CSR responding STA, such as a slave AP as described above. As shown in FIG. 18, example process 1800 may include steps 1802 and 1804.

In step 1802, process 1800 may include receiving from an AP a first PPDU comprising an indication to measure a receive power of a second PPDU transmitted by a second STA.

In an embodiment, the first STA may be an AP. For example, the first STA and the AP may be members of a coordinated set of APs. The first STA may be a slave AP in the coordinated set of APs.

In an embodiment, the first PPDU may further comprise an indication of a first resource allocated to the second STA for transmission of the second PPDU during a first time period. The first time period may start a Short Interframe Space (SIFS) duration after the first PPDU.

In an embodiment, the first PPDU may comprise a Triggering Frame.

In an embodiment, the second PPDU may comprise a TB PPDU. In another embodiment, the second PPDU may comprise a TB Null Data Packet (NDP).

In an embodiment, process 1800 may further include, after step 1802, measuring the receive power of the second PPDU transmitted by the second STA.

In step 1804, process 1800 may include receiving a third PPDU comprising a PSR parameter. The PSR parameter may be a modified PSR parameter, PSR′, as described above.

In an embodiment, the third PPDU may further comprise an indication of a second resource allocated to the first STA for transmission of the fourth PPDU during a second time period. The second time period may start a SIFS duration after the third PPDU.

In an embodiment, the third PPDU may further comprise a duration of the fourth PPDU.

In an embodiment, the third PPDU may comprise an Announcement Frame for APs in the coordinated set of APs. For example, the third PPDU may be a CSR Announcement frame.

In step 1806, process 1800 may include transmitting a fourth PPDU using a transmit power based on the PSR parameter and the receive power of the second PPDU.

In an embodiment, process 1800 may include, before step 1806, determining a maximum transmit power for the fourth PPDU based on the PSR parameter and the measured receive power of the second PPDU. In an embodiment, step 1806 may further include transmitting the fourth PPDU with the transmit power set in accordance with the determined maximum transmit power.

In an embodiment, the fourth PPDU may comprise a Triggering Frame that solicits a TB PPDU from a third STA.

In an embodiment, the PSR parameter may be based on an interference level at the second STA while receiving a fifth PPDU from the AP. In an embodiment, the interference level at the second STA corresponds to a maximum interference level that the second STA tolerates, while receiving the fifth PPDU, due to transmission of the fourth PPDU by the first STA.

In an embodiment, process 1800 may further comprise receiving a Triggering Frame soliciting a sixth PPDU from the first STA, the sixth PPDU indicating whether the first STA has pending frames to transmit. In an embodiment, the Triggering Frame may comprise an NDP Feedback Report Poll. In an embodiment, the sixth PPDU may comprise an NDP Feedback Report.

1. A first station (STA) comprising:
one or more processors; and
memory storing instructions that, when executed by the one or more processors, cause the first STA to:
receive from an access point (AP) a first physical layer protocol data unit (PPDU) comprising an indication to measure a receive power of a second PPDU transmitted by a second STA;
receive from the AP a third PPDU comprising a parameterized spatial reuse (PSR) parameter; and
transmit a fourth PPDU using a transmit power based on the PSR parameter and the receive power of the second PPDU.

2. The first STA of claim 1, wherein the instructions, when executed by the one or more processors, further cause the first STA to:
determine a maximum transmit power for the fourth PPDU based on the PSR parameter and the receive power; and
transmit the fourth PPDU with the transmit power set in accordance with the maximum transmit power.

3. The first STA of claim 1, wherein the first PPDU further comprises an indication of a first resource allocated to the second STA for transmission of the second PPDU during a first time period.

4. The first STA of claim 3, wherein the first time period starts a short interframe space (SIFS) duration after the first PPDU.

5. The first STA of claim 1, wherein the third PPDU comprises an indication of a second resource allocated to the first STA for transmission of the fourth PPDU during a second time period.

6. The first STA of claim 5, wherein the second time period starts a SIFS duration after the third PPDU.

7. The first STA of claim 1, wherein the PSR parameter is based on an interference level at the second STA while receiving a fifth PPDU from the AP.

8. The first STA of claim 7, wherein the interference level at the second STA corresponds to a maximum interference level that the second STA tolerates, while receiving the fifth PPDU, due to transmission of the fourth PPDU by the first STA.

9. The first STA of claim 8, wherein the first PPDU comprises a triggering frame, and wherein the second PPDU comprises a trigger based (TB) PPDU.

10. An access point (AP) comprising:
one or more processors; and
memory storing instructions that, when executed by the one or more processors, cause the AP to:
transmit a first physical layer protocol data unit (PPDU) comprising an indication to a first station (STA) to measure a receive power of a second PPDU transmitted by a second STA; and
transmit a third PPDU comprising an indication of a parameterized spatial reuse (PSR) parameter for use by the first STA to determine a transmit power for a fourth PPDU.

11. The AP of claim 10, wherein the transmit power is a maximum transmit power of the fourth PPDU.

12. The AP of claim 10, wherein the first PPDU further comprises an indication of a first resource allocated to the second STA for transmission of the second PPDU during a first time period.

13. The AP of claim 12, wherein the first time period starts a short interframe space (SIFS) duration after the first PPDU.

14. The AP of claim 10, wherein the third PPDU comprises an indication of a second resource allocated to the first STA for transmission of the fourth PPDU during a second time period.

15. The AP of claim 14, wherein the instructions, when executed by the one or more processors, further cause the AP to transmit a fifth PPDU comprising a data frame to the second STA during the second time period.

16. The AP of claim 15, wherein the instructions, when executed by the one or more processors, further cause the AP to determine the PSR parameter based on an interference level at the second STA while receiving the fifth PPDU.

17. The AP of claim 16, wherein the interference level at the second STA corresponds to a maximum interference level that the second STA tolerates, while receiving the fifth PPDU, due to transmission of the fourth PPDU by the first STA.

18. The AP of claim 10, wherein the first PPDU comprises a triggering frame, and wherein the second PPDU comprises a trigger based (TB) PPDU.

19. A non-transitory computer-readable medium comprising instructions that, when executed by one or more processors of a first station (STA), cause the first STA to:
receive from an access point (AP) a first physical layer protocol data unit (PPDU) comprising an indication to measure a receive power of a second PPDU transmitted by a second STA;
receive from the AP a third PPDU comprising a parameterized spatial reuse (PSR) parameter; and
transmit a fourth PPDU using a transmit power based on the PSR parameter and the receive power of the second PPDU.

20. The non-transitory computer-readable medium of claim 19, wherein the first PPDU further comprises an indication of a first resource allocated to the second STA for transmission of the second PPDU during a first time period.
